(19) United States
(12) Patent Application Publication
(10) Pub. No.: US 2025/0235810 A1
(43) Pub. Date: Jul. 24, 2025

(54) CARBON DIOXIDE RECOVERY DEVICE

(71) Applicant: HONDA MOTOR CO., LTD., Tokyo (JP)

(72) Inventors: Hiroka SHIGI, Saitama (JP); Subaru MATSUMOTO, Saitama (JP); Toshiyuki INABA, Saitama (JP)

(21) Appl. No.: 19/018,262

(22) Filed: Jan. 13, 2025

(30) Foreign Application Priority Data
Jan. 19, 2024 (JP) 2024-006880

(51) Int. Cl. B01D 53/04; B01D 53/96

(52) U.S. Cl. CPC B01D 53/04; B01D 53/96; B01D 2257/504; B01D 2259/40007

(57) ABSTRACT

A carbon dioxide recovery device is provided having high energy efficiency which can curtain the energy required in temperature rise of a sorbent material in a desorption process by enabling utilization of heat of adsorption. A carbon dioxide recovery device includes: a module including a sorbent material inside thereof, and executes an adsorption process of aspirating gas containing carbon dioxide and adsorbing the carbon dioxide to the sorbent material; and a desorption process of desorbing the carbon dioxide from the sorbent material by heating in a state where a periphery of the sorbent material is reduced pressure; and a tank storing a cooling medium for the module, in which the adsorption process performs heat recovery by flowing the cooling medium to the module, when a difference between a temperature of the sorbent material and a temperature of the cooling medium in the tank is a first threshold or more.

This application is based on and claims the benefit of priority from Japanese Patent Application No. 2024-006880, filed on 19 Jan. 2024, the content of which is incorporated herein by reference.

### BACKGROUND OF THE INVENTION

### Field of the Invention

The present invention relates to a carbon dioxide recovery device.

### Related Art

Conventionally, technology for recovering carbon dioxide from gas which contains carbon dioxide such as atmospheric air has been known. As a document disclosing this type of technology, Japanese Unexamined Patent Application (Translation of PCT Application), Publication No. 2017-528318 can be exemplified. Japanese Unexamined Patent Application (Translation of PCT Application), Publication No. 2017-528318 discloses a method of separating gaseous carbon dioxide from gas mixture by a cyclic adsorption/desorption using an sorbent material which adsorbs gaseous carbon dioxide.
Patent Document 1: Japanese Unexamined Patent Application (Translation of PCT Application), Publication No. 2017-528318

### SUMMARY OF THE INVENTION

However, in a desorption process of desorbing the carbon dioxide adsorbed to the sorbent material from this sorbent material, it is necessary to establish the sorbent material in a high-temperature state. In order to raise the sorbent material from room temperature to a temperature enabling desorption, a great amount of thermal energy from outside becomes necessary. On the other hand, in the adsorption process of adsorbing carbon dioxide to the sorbent material, although heat of adsorption is generated in the sorbent material, this heat of adsorption has not been used. In the conventional technology, there has been room for improvement in the point of improving the efficiency of the energy required in raising the temperature of the sorbent material.

The present invention has an object of providing a carbon dioxide recovery device having high energy efficiency which can curb the energy required in raising the temperature of the sorbent material in a desorption process by making the heat of adsorption utilizable.

The present disclosure solves this problem by way of the following such means. It should be noted that, in order to facilitate understanding, a description is provided by assigning reference symbols corresponding to the embodiments of the present disclosure; however, it is not to be limited thereto.

A first aspect of the present invention is a carbon dioxide recovery device (1) including: a module (11) that includes a sorbent material (12) inside thereof, and executes an adsorption process of aspirating gas containing carbon dioxide and adsorbing the carbon dioxide to the sorbent material (12); and a desorption process of desorbing the carbon dioxide from the sorbent material (12) by heating in a state where a periphery of the sorbent material (12) is reduced pressure; and a tank (82) that stores a cooling medium that cools the module (11), in which the adsorption process performs heat recovery by flowing the cooling medium to the module (11), when a difference between a temperature of the sorbent material (12) and a temperature of the cooling medium in the tank (82) is a first threshold or more.

According to a second aspect of the present invention, in the carbon dioxide recovery device (1) as described in the first aspect, flow of the cooling medium to the module (11) is stopped when a difference between an inlet temperature at a position at which the cooling medium enters the module (11) and an outlet temperature at a position where the cooling medium exits from the module (11) becomes smaller than a second threshold.

According to a third aspect of the present invention, in the carbon dioxide recovery device (1) as described in the first or second aspect, flow of the cooling medium to the module (11) is stopped when a difference between a temperature of the sorbent material (12) and a temperature of the cooling medium in the tank (82) becomes smaller than a third threshold.

According to the present disclosure, it is possible to provide a carbon dioxide recovery device having high energy efficiency which can curb the energy required in raising the temperature of the sorbent material in a desorption process by making the heat of adsorption utilizable.

### BRIEF DESCRIPTION OF THE DRAWINGS

FIG. 1 is a schematic diagram showing a configuration related to a flow of a liquid in a carbon dioxide recovery device 1 according to an embodiment of the present invention;

FIG. 2 is a schematic diagram showing a configuration related to a flow of gas in a module 11 of the carbon dioxide recovery device 1 according to the present embodiment;

FIG. 3 is a schematic diagram showing a heat supply path during heat of adsorption non-recovery in an adsorption process;

FIG. 4 is a schematic diagram showing a heat supply path during heat of adsorption recovery in the adsorption process;

FIG. 5 is a graph for describing heat transfer of the module 11 including during heat of adsorption non-recovery and during heat of adsorption recovery in the adsorption process; and

FIG. 6 is a flowchart showing an example of the flow of operations in heat of adsorption recovery by the carbon dioxide recovery device according to the present embodiment.

### DETAILED DESCRIPTION OF THE INVENTION

Hereinafter, embodiments of the present invention will be described by referencing the drawings.

### <Overall Configuration>

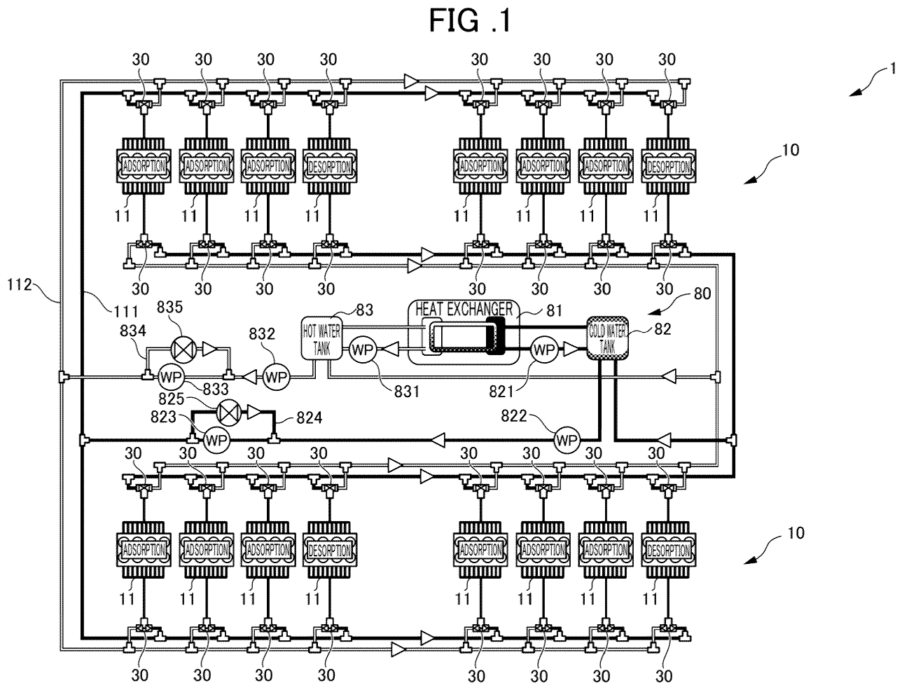

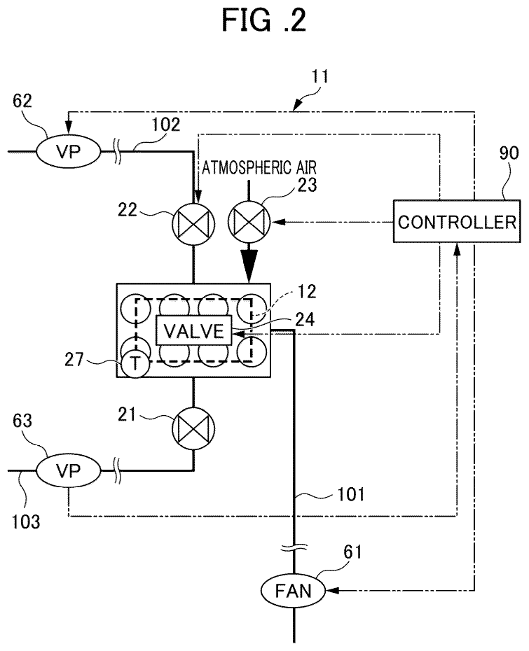

FIG. 1 is a schematic diagram showing a configuration related to a flow of a liquid in a carbon dioxide recovery device 1 according to an embodiment of the present invention. FIG. 2 is a schematic diagram showing a configuration related to a flow of gas in a module 11 of the carbon dioxide recovery device 1 according to the present embodiment. It should be noted that illustrations of configurations related to the flow of gas in the carbon dioxide recovery device 1 in FIG. 1 are abbreviated.

The carbon dioxide recovery device 1 of the present embodiment, for example, is applied to direct air recovery technology (DAC: Direct Air Capture) which recovers the carbon dioxide in the atmosphere, in order to decrease the carbon dioxide concentration in the atmosphere. The carbon dioxide recovered by the carbon dioxide recovery device 1 is stored in the ground, and is reused as a fuel or raw material.

As shown in FIGS. 1 and 2, the carbon dioxide recovery device 1 according to the present embodiment includes a module unit 10, a fan 61, a vacuum pump 62, a carbon dioxide recovery pump 63, a heat exchange device 80, and a controller 90.

The module unit 10 is configured by a plurality of the modules 11 which adsorb carbon dioxide being arranged in a line. In the present embodiment, a total number of sixteen of the modules 11 are arranged by a pair of left and right module units 10.

As shown in FIG. 2, the module 11 is a carbon dioxide recovery module which includes a sorbent material 12, a first valve 21, a second valve 22, a third valve 23, a fourth valve 24, and a sorbent material temperature sensor 27.

The sorbent material 12 is arranged inside of the module 11 in order to adsorb carbon dioxide. The sorbent material 12 is a member in particle form, and has a property of adsorbing carbon dioxide in a low-temperature state (for example, range of −30° C. to 50° C.), and desorbing (releasing) carbon dioxide in a state of high temperature (for example, range of 50° C. to 110° C.) and low concentration of carbon dioxide in the surroundings. As such a sorbent material 12, for example, a carbon dioxide sorbent material of a solid amine configured by supporting an amine on a porous material such as silica, or the like can be exemplified.

The first valve 21 is a switching value arranged at a connection of the module 11 with a carbon dioxide line 103 recovering the carbon dioxide. A carbon dioxide recovery pump 63 is arranged in the carbon dioxide line 103. The second valve 22 is a switching valve arranged at a connection of the module 11 with the vacuum line 102 in which the vacuum pump 62 is arranged. The third valve 23 is a switching value arranged at an inlet which suctions atmospheric air, etc. into the module 11. The fourth valve 24 is a switching valve arranged at a connection of the module 11 with an adsorption line 101. A fan 61 is arranged in the adsorption line 101.

The first valve 21, the second valve 22, the third valve 23 and the fourth valve 24 are all controlled to open and close by the controller 90. The first valve 21, the second valve 22, the third valve 23 and the fourth valve 24, for example, are configured by butterfly valves which are normal open. The sorbent material temperature sensor 27 measures the temperature of the sorbent material 12. The measurement information of the sorbent material temperature sensor 27 is sent to the controller 90.

The adsorption line 101 is branched to connect to each of the respective modules 11. The fan 61 is arranged at portion of the adsorption line 101 at which a branching portion merges. The fan 61 produces flow of gas from “intake” to “exhaust” relative to the module 11 through the adsorption line 101 by being driven. The atmospheric air is thereby supplied into the module 11.

The vacuum line 102 is branched to connect to each of the respective modules 11. The vacuum pump 62 is arranged at a portion of the vacuum line 102 at which the branched portions merge together. The vacuum pump 62 aspirates gas inside of the module 11 through the vacuum line 102 by way of being driven to make the inside of the module 11 a vacuum state or bring it close to a vacuum state.

The carbon dioxide line 103 is branched to connect to each of the respective modules 11. At a portion of the carbon dioxide line 103 at which the branched portion merges, the carbon dioxide recovery pump 63 is arranged. The carbon dioxide recovery pump 63 causes the suction force to act on carbon dioxide flowing in the carbon dioxide line 103, and stores the recovered carbon dioxide in a tank (not shown) which stores carbon dioxide.

Referring back to FIG. 1, the heat exchange device 80 will be described. The heat exchange device 80, upon each module 11 of the module unit 10 performing the desorption process, supplies thermal energy for heating inside this module 11 up to a predetermined temperature. In addition, the heat exchange device 80 recovers thermal energy which is unneeded upon each module 11 performing the adsorption process.

The heat exchange device 80 of the present embodiment includes: a heat exchanger 81, a cold water tank 82, a cold water line 111, a hot water tank 83, a hot water line 112, and three-way valves 30.

The heat exchanger 81 performs heat exchange between a heat transfer medium flowing in the cold water line 111, and a heat transfer medium flowing in the hot water line 112. The heat exchanger 81, for example, is a heat pipe. The heat transfer medium, for example, is a liquid such as water. The heat transfer medium flowing in the cold water line 111 is cooled by the heat transfer occurring in the heat exchanger 81, and the heat transfer medium flowing in the hot water line 112 is heated.

The cold water tank 82 stores the heat transfer medium flowing in the cold water line 111. The heat transfer medium flowing in the cold water line 111 is stored in the cold water tank 82, and then is sent to the heat exchanger 81. In addition, the heat transfer medium cooled by the heat exchanger 81 is returned to the cold water tank 82, and then is sent to each module 11 through the cold water line 111. A heat-exchanger circulation water pump 821 is arranged between the cold water tank 82 and the heat exchanger 81 in the cold water line 111. By driving heat-exchanger circulation water pump 821, the heat transfer medium flowing in the cold water line 111 circulates between the cold water tank 82 and the heat exchanger 81.

The cold water line 111 is branched to connect to the upstream side and the downstream side of each of the respective modules 11, and connects the cold water tank 82 with each of the modules 11. In addition, a first cold-water circulation water pump 822 and a second cold-water circulation water pump 823 are arranged between the cold water tank 82 and each module 11 in the cold water line 111. In addition, a circulation line 824 which returns from the downstream side to the upstream side of the second cold-water circulation water pump 823 is arranged in the cold water line 111. A circulation valve 825 is arranged in this circulation line 824.

The hot water tank 83 stores the heat transfer medium flowing in the hot water line 112. The heat transfer medium flowing in the hot water line 112 is stored in the hot water tank 83, and then sent to the heat exchanger 81. In addition, the heat transfer medium heated by the heat exchanger 81 is returned to the hot water tank 83, and then sent to each module 11 through the hot water line 112. A heat-exchanger circulation water pump 831 is arranged between the hot water tank 83 and the heat exchanger 81 in the hot water line 112. By driving the heat-exchanger circulation water pump 831, the heat transfer medium flowing in the hot water line 112 circulates between the hot water tank 83 and the heat exchanger 81.

The hot water line 112 is branched to connect to the upstream side and the downstream side of each of the respective modules 11, and connects the hot water tank 83 and each module 11. In addition, a first hot-water circulation water pump 832 and a second hot-water circulation water pump 833 are arranged between the hot water tank 83 and each module 11 in the hot water line 112. In addition, a circulation line 834 which returns from the downstream side to the upstream side of the second hot-water circulation water pump 833 is arranged in the hot water line 112. A circulation valve 835 is arranged in this circulation line 834.

The three-way valve 30 is connected to the cold water line 111, the hot water line 112 and the module 11. Three-way valves 30 are respectively arranged at the upstream side and the downstream side of the module 11. The three-way valve 30 is configured to be switchable between a cold-water connection state connecting the cold water line 111 and the module 11, a hot-water connection state connecting the hot water line 112 and the module 11, and a closed state blocking connection between the cold water line 111 and the hot water line 112 with the module 11.

The flow path switching of the three-way valve 30 is controlled by the controller 90. The heat transfer medium is introduced to the module 11 through the three-way valve 30 arranged on the upstream side, and the heat transfer medium is returned to the heat exchanger 81 side through the three-way valve 30 arranged on the downstream side.

Next, the controller 90 will be described. The controller 90 controls the operation of each part of the carbon dioxide recovery device 1. The controller 90 controls operations such as driving and stopping of devices used in the adsorption and desorption of carbon dioxide. The controller 90 performs switching control, etc. of the first valve 21, the second valve 22, the third valve 23 and the fourth valve 24 provided to each module 11. In addition, the controller 90 performs driving control of the fan 61, the vacuum pump 62, the carbon dioxide recovery pump 63, the heat-exchanger circulation water pump 821, the first cold-water circulation water pump 822, the second cold-water circulation water pump 823, the heat-exchanger circulation water pump 831, the first hot-water circulation water pump 832 and the second hot-water circulation water pump 833, and switching control of the circulation valve 825 and the circulation valve 835.

The controller 90, for example, is a computer that has a CPU (Central Processing Unit), ROM (Read Only Memory), RAM (Random Access Memory), etc. The controller 90 may be configured as one unit, or may be configured by several units.

### <Recovery of Carbon Dioxide>

Next, control for recovering carbon dioxide by the controller 90 will be described. The carbon dioxide recovery device 1 removes and recovers carbon dioxide from the air by alternately performing an adsorption process of adsorbing carbon dioxide in gas aspirated such as atmospheric air to the sorbent material 12 in the module 11, and a desorption process of desorbing the carbon dioxide adsorbed to the sorbent material 12, and then compresses the desorbed carbon dioxide and stores in a tank (not shown). In the present embodiment, the adsorption process and the desorption process are performed with a time of adsorption process: a time of desorption process=3:1.

The adsorption process is a process of adsorbing carbon dioxide to the sorbent material 12 inside the module 11. In the adsorption process, the third valve 23 and the fourth valve 24 of the module 11 are opened, and the first valve 21 and the second valve 22 are closed. The fan 61 is driven, whereby a flow of gas from upstream to downstream is generated, and the gas containing carbon dioxide (for example, atmospheric air) is aspirated through the third valve 23. The aspirated gas passes through the sorbent material 12 inside the module 11. At this time, the inside of the module 11 is room temperature (25° C.), and the carbon dioxide in the gas is adsorbed to the sorbent material 12. Gas other than carbon dioxide, for example, nitrogen, oxygen, etc., are exhausted to outside of the carbon dioxide recovery device 1 through the fourth valve 24 and the adsorption line 101. In addition, in the present embodiment, when satisfying specific conditions in this adsorption process, the recovery operation of the heat of adsorption is performed. The recovery operation of this heat of adsorption will be described later.

The desorption process is a process of desorbing the carbon dioxide on the sorbent material 12 within the module 11. In the desorption process, the first valve 21, the third valve 23 and the fourth valve 24 of the module 11 are closed, and the second valve 22 is opened. The vacuum pump 62 runs to aspirate inside of the module 11, and reduces the pressure to a vacuum state or brings it close to a vacuum state. Simultaneously, the heat transfer medium serving as a heat source flows with the module 11 to supply thermal energy by way of the heat exchange device 80, whereby the sorbent material 12 of the module 11 is raised in temperature.

By temperature-rise control of the sorbent material 12, the sorbent material 12 is also heated to a predetermined temperature (for example, 80° C.) adequate for the desorption process, and the carbon dioxide adsorbed to the sorbent material 12 is desorbed. Next, the second valve 22, the third valve 23 and the fourth valve 24 are closed, the first valve 21 is opened, and the carbon dioxide recovery pump 63 is driven, whereby the carbon dioxide desorbed through the carbon dioxide line 103 is stored in a tank (not shown). In the present embodiment, the respective processes are controlled so that, among the sixteen of the modules 11, twelve of them execute the adsorption process, and the remaining four perform the desorption process.

### <Recovery Operation of Heat of Adsorption (Control)>

In the adsorption process, when carbon dioxide adsorbs to the sorbent material 12, heat of adsorption is generated. This heat of adsorption has not been utilized in conventional carbon dioxide recovery devices. However, if it is possible to utilize this heat of adsorption in the temperature rise of the sorbent material 12 for the desorption process, the energy required in the temperature rise of the sorbent material 12 can be curbed. Therefore, the carbon dioxide recovery device 1 of the present embodiment performs recovery operation of the heat of adsorption. This recovery operation of the heat of adsorption is described below.

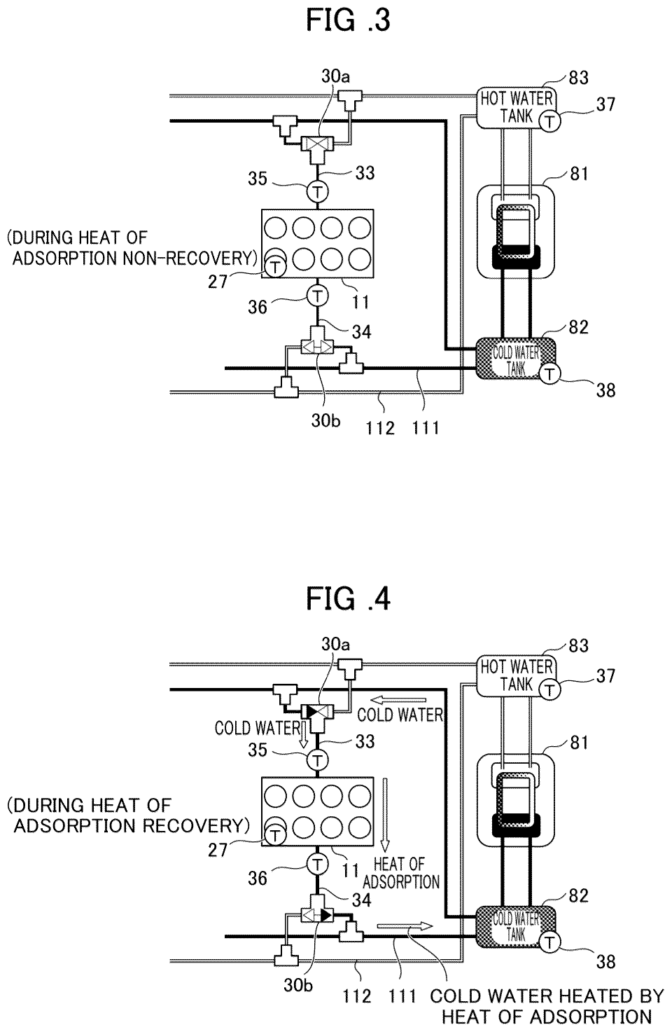

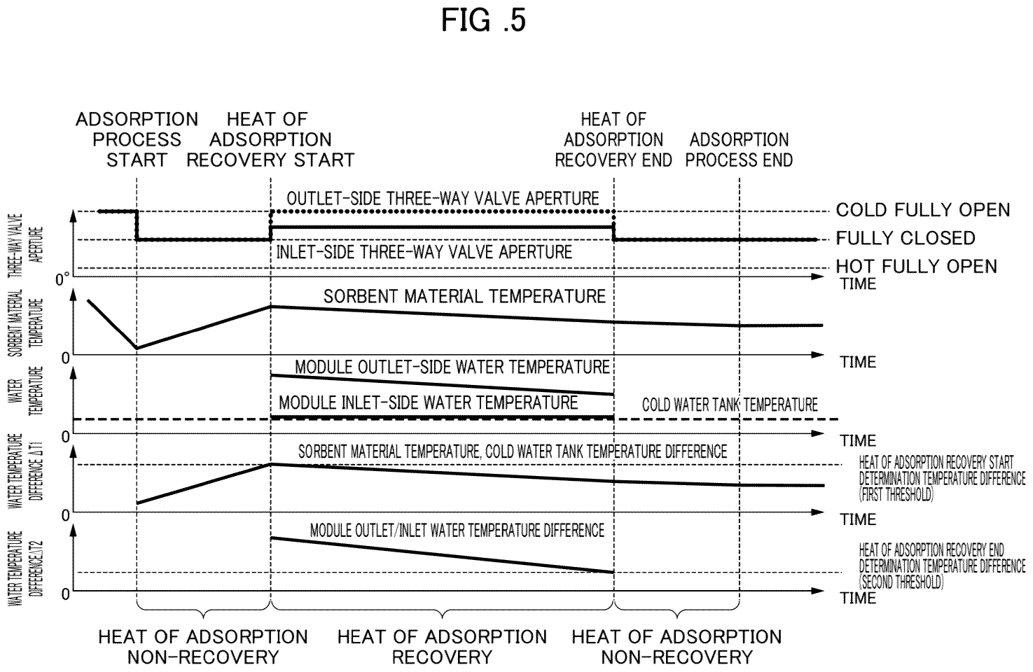

FIG. 3 is a schematic diagram showing a thermal supply path during heat of adsorption non-recovery in the adsorption process. FIG. 4 is a schematic diagram showing a thermal supply path during heat of adsorption recovery in the adsorption process. FIG. 5 is a graph for describing heat transfer of the module 11 including during heat of adsorption non-recovery and during heat of adsorption recovery in the adsorption process. It should be noted that illustration of the remaining modules 11 is omitted from FIGS. 3 to 5.

First, the structure supplying the heat transfer medium to the module 11 will be described. As shown in FIGS. 3 and 4, the module 11 includes: an inlet-side flow path 33 connected to an inlet to which the heat transfer medium flows, and an outlet-side flow path 34 connected to an outlet from which the heat transfer medium flows. A three-way valve 30 is arranged at the upstream-side end of the inlet-side flow path 33, and a three-way valve 30 is arranged at the downstream-side end of the outlet-side flow path 34.

An inlet temperature sensor 35 is provided to the inlet-side flow path 33. The inlet temperature sensor 35 measures the temperature of the heat transfer medium flowing into the module 11 (hereinafter also called inlet temperature), and this measurement information is sent to the controller 90. An outlet temperature sensor 36 is provided to the outlet-side flow path 34. The outlet temperature sensor 36 measures the temperature of the heat transfer medium flowing out from the module 11 (hereinafter also called outlet temperature), and this measurement information is sent to the controller 90. In addition, the carbon dioxide recovery device 1 of the present embodiment further includes a hot-water tank temperature sensor 37, and a cold-water tank temperature sensor 38. The hot-water tank temperature sensor 37 measures the temperature of the hot-water tank 83, and this measurement information is sent to the controller 90. The cold-water tank temperature sensor 38 measures the temperature of the cold-water tank 82, and this measurement information is sent to the controller 90.

Operation during heat of adsorption non-recovery of the adsorption process will be described. The state during heat of adsorption non-recovery of the adsorption process is shown in FIG. 3. In the state during heat of adsorption non-recovery of the adsorption process, due to already being cooled to a predetermined temperature (for example, 20° C.) by the cold water line 111 in the previous stage thereto, the controller 90 controls the inlet three-way valve 30a and the outlet three-way valve 30b to establish a state blocking the module 11 from both the cold water line 111 and the hot water line 112. In this state, the adsorption of carbon dioxide from atmospheric air, etc. introduced by driving of the fan 61 is performed.

As shown in FIG. 5, when starting the adsorption process, the temperature of the sorbent material 12 in the module 11 gradually rises due to the heat of adsorption being generated. When a temperature difference ΔT1 between the temperature of the cold water tank 82 obtained from the cold-water tank temperature sensor 38 and the temperature of the sorbent material 12 obtained from the sorbent-material temperature sensor 27 becomes a predetermined value (first threshold) or greater, the controller 90 controls the inlet three-way valve 30a to connect the cold water line 111 and the inlet-side flow path 33, and controls the outlet three-way valve 30b to connect the outlet-side flow path 34 and the cold-water line 111, and starts heat of adsorption recovery (state in FIG. 4). Herein, the first threshold is settable as appropriate; however, it is possible to set as 5° C., for example. It should be noted that, also during this heat of adsorption recovery, the fan 61 continues driving, and the adsorption of carbon dioxide is continued.

When starting the heat of adsorption recovery, the heat transfer medium (cold water), when passing through the module 11, recovers the heat of adsorption and is warmed, and the warmed cold water returns to the cold-water tank 82. With this warmed cold water, heat exchange is carried out in the heat exchanger 81, whereby the recovered heat of adsorption is utilized in the heating of the hot water. In the initial stage of heat of adsorption recovery, the temperature difference (module outlet/inlet water temperature difference ΔT2) between the inlet temperature measured by the inlet temperature sensor 35 and the outlet temperature measured by the outlet temperature sensor 36 is great; however, this module outlet/inlet water temperature difference gradually lowers as the heat recovery progresses. At the moment when this module outlet/inlet water temperature difference ΔT2 becomes no more than a predetermined value (second threshold), the controller 90 controls the inlet three-way valve 30a and the outlet three-way valve 30b to establish a state blocking the module 11 from both the cold water line 111 and the hot water line 112 (state shown in FIG. 3). Herein, the second threshold is settable as appropriate; however, it is possible to set as 5° C., for example. Subsequently, when a predetermined time elapses since adsorption start, the adsorption process is ended.

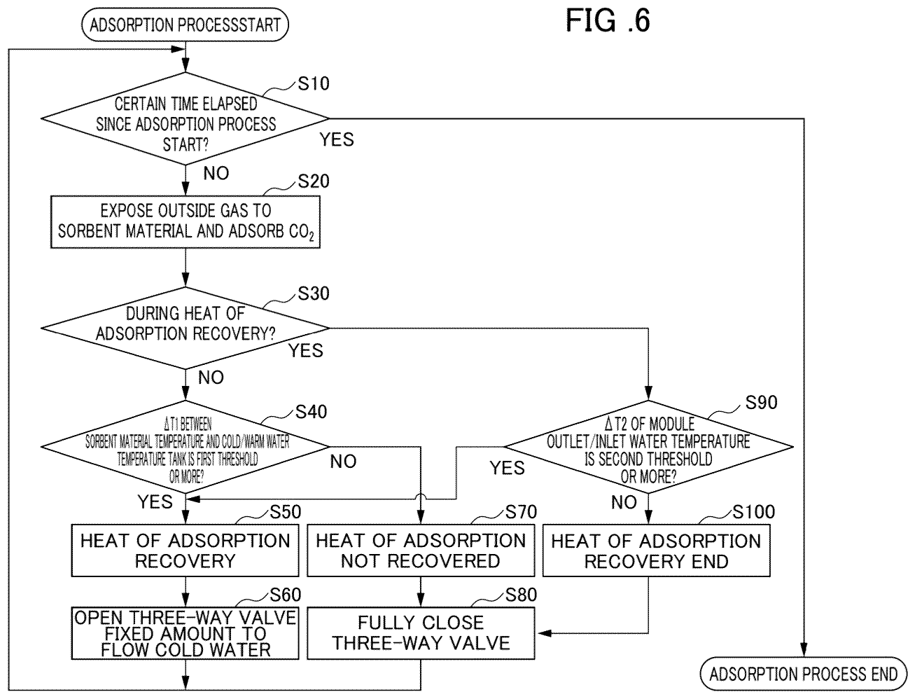

Next, the switching timing of the start and end of heat of adsorption recovery will be described referencing FIG. 6. FIG. 6 is a flowchart showing an example of the flow of operations of the heat of adsorption recovery by the carbon dioxide recovery device according to the present embodiment.

When the adsorption process starts, in Step S10, the controller 90 determines whether a certain time has elapsed since the adsorption process start. In the case of a certain time elapsing since the adsorption process start, the controller 90 ends the processing of the adsorption process (Step S10: Yes). In the case of a certain time not elapsing since the adsorption process start, the controller 90 advances the processing of the adsorption process to Step S20 (Step S10: No).

In Step S20, the controller 90 exposes outside air to the sorbent material 12 to perform adsorption of carbon dioxide. In the course of adsorption in this Step S20, the temperature of the sorbent material 12 rises gradually by the heat of adsorption, as shown in FIG. 5.

In Step S30, the controller 90 determines whether being during heat of adsorption recovery. In the case of being during heat recovery, the controller 90 advances the processing of the adsorption process to Step S90 (Step S30: Yes). In the case of not being during heat recovery, the controller 90 advances the processing of the adsorption process to Step S40 (Step S30: No).

In Step S40, the controller 90 determines whether the temperature difference ΔT1 between the temperature of the cold water tank 82 obtained from the cold-water tank temperature sensor 38 and the temperature of the sorbent material 12 obtained from the sorbent-material temperature sensor 27 is a predetermined value (first threshold) or more. In the case of ΔT1 being the predetermined value (first threshold) or more, the controller 90 advances the processing of the adsorption process to Step S50 (Step S40: Yes). In the case of ΔT1 not being the predetermined value (first threshold) or more, the controller 90 advances the processing of the adsorption process to Step S70 (Step S40: No).

In Step S50, the controller 90 performs a decision to perform heat of adsorption recovery. In Step S60, the controller 90 controls the inlet three-way valve 30a to connect the cold water line 111 and the inlet-side flow path 33, and controls the outlet three-way valve 30b to connect the outlet-side flow path 34 and the cold water line 111, and forms a flow of heat of adsorption recovery cold water.

In Step S70, the controller 90 performs a decision not to perform heat of adsorption recovery. In Step S80, the controller 90 controls the inlet three-way valve 30a and the outlet three-way valve 30b to establish a state completely closing both, and establishes a state blocking the module 11 from both the cold water line 111 and the hot water line 112.

In Step S90, the controller 90 determines whether the temperature difference (module outlet/inlet water temperature difference ΔT2) between the inlet temperature measured by the inlet temperature sensor 35 and the outlet temperature measured by the outlet temperature sensor 36 is a predetermined value (second threshold) or more. In the case of ΔT2 being the predetermined value (second threshold) or more, the controller 90 advances the processing of the adsorption process to Step S50 (Step S90: Yes). In the case of ΔT2 not being the predetermined value (second threshold) or more, the controller 90 advances the processing of the adsorption process to Step S100 (Step S90: No).

In Step S100, the controller 90 performs a decision to end the heat of adsorption recovery, and advances the processing of the adsorption process to Step S80.

It should be noted that the flow of operations exemplified above was described with the controller 90 deciding whether or not to end the heat of adsorption recovery, by determining whether the module outlet/inlet water temperature difference ΔT2 is the second threshold or more in Step S90. The flow is not limited to such operations, for example, and may be configured so as to end the heat of adsorption recovery (stop flowing cooling medium to the module) when the difference between the temperature of the sorbent material 12 and the temperature of a cooling medium in the cold water tank 82 becomes smaller than a third threshold.

As described above, the carbon dioxide recovery device 1 according to the present embodiment performs heat recovery in the adsorption process by flowing the cooling medium to the module 11, when the difference between the temperature of the sorbent material 12 and the temperature of the cooling medium in the cold water tank 82 is the first threshold or more; therefore, it is possible to effectively utilize the heat of adsorption which has not been conventionally utilized, and thus the heat amount required in heat exchange of the heat exchanger 81 can be supplemented. Consequently, it is possible to provide the carbon dioxide recovery device 1 having high energy efficiency which can curb the energy required in raising the sorbent material 12 in the desorption process.

In addition, the carbon dioxide recovery device 1 stops flowing the cooling medium to the module 11, when the difference between the inlet temperature at a position at which the cooling medium enters the module 11, and the outlet temperature at a position where the cooling medium exits from the module 11 becomes smaller than the second threshold. The module cooling performance in the overall carbon dioxide recovery device can thereby be maintained.

In addition, it may be configured so that, when the difference between the temperature of the sorbent material 12 and the temperature of the cooling medium in the cold water tank 82 becomes smaller than the third threshold, the carbon dioxide recovery device 1 stops flowing the cooling medium to the module 11. The module cooling performance in the overall carbon dioxide recovery device can thereby be maintained.

Although embodiments of the present invention have been described above, it is not to be limited to the aforementioned embodiments and modified examples. In addition, the effects described in the above embodiments are merely exemplifying the preferred effects, and the effects thereof are not limited to those described in the above embodiments.

### EXPLANATION OF REFERENCE NUMERALS

1 carbon dioxide recovery device
11 module
12 sorbent material
30 three-way valve
61 fan
62 vacuum pump
63 carbon dioxide recovery pump
80 heat exchange device
81 heat exchanger
82 cold water tank
83 hot water tank

What is claimed is:

1. A carbon dioxide recovery device comprising:
a module that includes a sorbent material inside thereof, and executes an adsorption process of aspirating gas containing carbon dioxide and adsorbing the carbon dioxide to the sorbent material; and a desorption process of desorbing the carbon dioxide from the sorbent material by heating in a state where a periphery of the sorbent material is reduced pressure; and
a tank that stores a cooling medium that cools the module,
wherein the adsorption process performs heat recovery by flowing the cooling medium to the module, when a difference between a temperature of the sorbent material and a temperature of the cooling medium in the tank is a first threshold or more.

2. The carbon dioxide recovery device according to claim 1, wherein flow of the cooling medium to the module is stopped when a difference between an inlet temperature at a position at which the cooling medium enters the module and an outlet temperature at a position where the cooling medium exits from the module becomes smaller than a second threshold.

3. The carbon dioxide recovery device according to claim 1, wherein flow of the cooling medium to the module is stopped when a difference between a temperature of the sorbent material and a temperature of the cooling medium in the tank becomes smaller than a third threshold.

4. The carbon dioxide recovery device according to claim 2, wherein flow of the cooling medium to the module is stopped when a difference between a temperature of the sorbent material and a temperature of the cooling medium in the tank becomes smaller than a third threshold.
